(19) United States
(12) Patent Application Publication
(10) Pub. No.: US 2005/0107087 A1
(43) Pub. Date: May 19, 2005

(54) Method for service management in communications system

(75) Inventors: Markku T. Makinen, Espoo (FI); Mika Kiikkila, Espoo (FI); Zhi-Chun Honkasalo, Kauniainen (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/871,383

(22) Filed: Jun. 21, 2004

(30) Foreign Application Priority Data
Nov. 19, 2003 (GB) 0326944.6

(51) Int. Cl. H04Q 7/20

(52) U.S. Cl. 455/450; 455/451; 455/452.1

(57) ABSTRACT

A method for service management in a telecommunications network is disclosed, wherein at least one service is accessible via said network, and the network is managed by management systems. The method includes the step of providing common traffic categories. The method also includes the step of providing for said common traffic categories information as to how the respective common traffic categories are to be treated in the network. The method also includes the step of allocating one of the common traffic categories to at least one service. The method also includes the step of treating the service in the network in accordance with the information.

### FIELD OF THE INVENTION

This invention relates to a method and apparatus for managing services in a telecommunications system. The invention is especially, but not exclusively, suitable for implementation in the UMTS (Universal Mobile Telecommunications System)/GPRS (general packet radio system) architecture.

### BACKGROUND OF THE INVENTION

Telecommunication network systems such as the UMTS are managed by a series of management functions of a Telecommunications Management Network (TMN). Principles for the TMN are presented by ITU-T (Telecommunication Standardization Sector of the International Telecommunication Union) in ITU-T recommendation M.3010, the contents of which are hereby incorporated by reference.

A TMN, as presented by ITU-T, may provide management functions and offer communications both between the Operations Systems (OSs) themselves, and between OSs and the various parts of the telecommunications network. OSs are physical blocks which perform operations systems functions (OSFs), and an OSF is a function block that processes information related to the telecommunications management for the purpose of monitoring/coordinating and/or controlling telecommunication functions including management functions (i.e. the TMN itself).

FIG. 1 taken from M.3010 shows the general relationship between a TMN and a telecommunications network, which it manages. It should be noted that even though the communication network shown in FIG. 1 is a public switched telephone network, TMN principles presented by ITU-T are valid for any kind of communications network, for example GSM (global system for mobile communications), UMTS (universal mobile telecommunications system), GPRS (general packet radio service), CDMA (code division multiple access), ATM (asynchronous data transfer) and SDH (synchronous digital hierarchy).

A telecommunication network consists of many types of telecommunications equipment and associated support equipment. When managed, such equipment is generally referred to as network elements (NEs). In addition of NEs, TMN may be used to manage e.g. the TMN itself, telecommunications services, and software provided by or associated with telecommunications services.

To deal with the complexity of telecommunications management, management functionality may be considered to be partitioned into logical layers. Management function layers as presented by ITU-T in recommendation M.3010 are a business management layer, a service management layer, a network management layer and an element management layer.

The element management layer manages each network element on an individual or group basis and supports an abstraction of the functions provided by the network element layer.

The network management layer provides a functionality to manage a network, as supported by the element management layer, by coordinating activity across the network and supports the “network” demands made by the service management layer. The network management layer knows what resources are available in the network, how these are interrelated and geographically allocated and how the resources are controlled. Furthermore, this layer is responsible for the technical performance of the actual network and will control the available network capabilities and capacity to give the appropriate accessibility and quality of service (QoS).

The service management layer is concerned with, and responsible for, the contractual aspects of services that are being provided to customers (subscribers) or available to potential new customers. Some of the main functions of this layer are service order handling, complaint handling and invoicing. The service management layer has several roles, for example interaction between service providers, interaction between services and customer interfacing. The customer interfacing provides the basic point of contact with customers for all service transactions including provision of service, accounts, QoS, etc.

The business management layer has responsibility for the total enterprise, e.g. an operator enterprise. The business management layer is included in the TMN architecture to facilitate the specification of capabilities that it requires of the other management layers.

The business management layer and the layers described above are further described in chapter 9.5 of the ITU-T recommendation M.3010.

The network management layer OSF is implemented into an operations support system (OSS) referred herein as network management system (NMS). NMS typically manages the telecommunications network and controls how different types of traffic are passed and treated through the network. For example with the help of NMS an operator or another service provider can define rules as to how traffic belonging to a particular traffic class (conversational class, streaming class, background class, and interactive class) is treated in the network.

The services provided to the subscribers and the service subscriptions are managed by the service management system (SMS). Thus the SMS provides the OSF on the service management layer. For example the SMS specifies what services are available in the network and also which services are available to which subscriber. Each service has a series of QoS requirements in order to function correctly and therefore expects certain characteristics from the network bearer in terms of delay (or latency), bandwidth and priority to access specific network resources for example.

In current systems the two most common forms of service, voice communication and text messaging (which is also known as short message service) use separate transport channels. The use of two separate channels for two services prevents any inconsistent treatment of services caused by an inconsistent treatment of data passing through the network. However if different services pass through the same transport channels, such as for instance pure voice communication and video-telecommunication data traffic passing through the same transport channel in a network there is a possibility that uniform treatment for a service type cannot be achieved as there is no uniform way between the management layers to map treatment of different traffic types with requirements set for different types of services and/or service subscriptions. Thus, it is not possible to configure the network resources in a consistent way to meet all requirements set for a service and/or a service subscription.

### SUMMARY OF THE INVENTION

It is an aim of the embodiments of the present invention to address the problem discussed previously.

There is provided according to one aspect of the invention a method for service management in a telecommunications network wherein at least one service is accessible via said network, and said network is managed by management systems, said method comprising the steps of: providing common traffic categories; providing for said common traffic categories information as to how the respective common traffic categories are to be treated in said network; allocating one of said common traffic categories to at least one service; treating said service in said network in accordance with said information.

The step of providing common traffic categories may comprise defining at least one parameter for at least one traffic category.

At least one of the common traffic categories may be characterized by at least one value or a range of values of said at least one parameter.

The plurality of parameters may be defined for at least one traffic category, and said at least one traffic category is characterized by values for each of the parameters.

The at least one parameter identifying said common traffic category may be at least one of following: traffic class (TC); allocation/retention priority (ARP); traffic handling priority (THP); bandwidth.

The method may comprise providing common traffic category groups, wherein said at least one group may comprise at least two of said common traffic categories.

The step of providing for said common traffic categories information may comprise the steps of: providing information for a first part of said telecommunications network as to how common traffic categories belonging to said at least one common traffic category group are to be treated in said first part of said telecommunications network.

According to a second aspect of the invention there is provided a communications system comprising: a first management function and a second management function, said first and second management functions arranged to use common traffic categories, said first management function being arranged to control that traffic is treated in dependence on an allocated common traffic category and said second management function is arranged to allocate a service an appropriate traffic category.

The communications system may further comprise a communications network, wherein said first management function may be arranged to control that traffic associated with said service is treated in said network according to the common traffic category allocated to the service.

The communications system may comprise at least one memory storing common traffic category information, wherein said at least one memory may be provided in said first and/or second management function.

A memory may be provided in each of said first and second management functions, wherein one memory may be arranged to store said common traffic category information and the other may be synchronized to the information stored in the other memory.

The memory may be provided separate from said first and second management functions, wherein said memory may be arranged to store said common traffic category information, and said memory may be accessible by both of said management functions.

The memory may be in a communications node of said network or in a third management function.

The categories may comprise a group of guaranteed bit rate categories.

The guaranteed bit rate categories may comprise at least one of a conversational data category and a streaming data category.

The categories may comprise a group of non-guaranteed bit rate categories.

The non-guaranteed bit rate classes may comprise at least one of a first interactive treatment with traffic handling priority 1, a second interactive data treatment with traffic handling priority 2, a third interactive data treatment with traffic handling priority 3, and a background data treatment.

The data classes may comprise three groups each group having a different allocation and/or retention and/or priority within the system.

The categories may comprise three groups each group having a different allocation and/or retention and/or priority.

The categories may comprise common traffic category groups, said common traffic category groups may comprise associated common traffic categories, wherein said first management function may be arranged to determine resources dependent on said common traffic category groups in a first part of said system, and to determine resources dependent on said data categories in a second part of said system.

The at least one communications node may be arranged to receive from said second management function information defining said allocated common traffic category for said service and from said first management function information about the allocated common traffic category.

The allocated common traffic category information may comprise at least one parameter relating to the treatment of traffic associated with said service.

The at least one communications node may comprise at least one of GGSN, RNC and SGSN

The second management function may be arranged to provide said traffic category information for said service to said at least one node via an HLR.

The communications system may be a UMTS architecture communications system.

The communications system may be a GPRS architecture communications system.

The first management function may be a network management system (NMS).

The second management function may be a service management system (SMS).

A system where n categories may be provided and a part of said network may be able to only process m categories where m<n, said n categories may be divided into m groups.

The first management function may be arranged to provide information relating to said traffic categories to at least one communications node.

The at least one network element to which said information relating to said traffic categories is passed may comprise at least one of a SGSN, GGSN, BSC and RNC.

The at least one communications node to which said information relating to traffic categories is passed may be arranged to enforce at least one parameter of an allocated traffic category.

According to a third aspect of the present invention there is provided a telecommunications network wherein at least one service is accessible via said network, and said network is managed by management systems, said network comprising: means providing common traffic categories; means providing information as to how said common traffic categories are to be treated in said network; means for allocating one of said common traffic categories to at least one service; wherein said network is arranged so that said service in said network is treated in accordance with said information as to how said common traffic categories are to be treated in said network.

The telecommunications network may comprise a first management system comprising said means providing common traffic categories and/or means providing information as to how said common traffic categories are to be treated in said network.

The telecommunications network may comprise a second management system comprising said means for allocating one of said common traffic categories to at least one service.

The means providing common traffic categories may comprise means providing at least one parameter, wherein at least one of said common traffic categories is characterized by at least one value or a range of said values of said at least one parameter.

The means providing common traffic categories may comprise means providing a plurality of parameters, wherein at least one of said common traffic categories is characterized by the values of said plurality of parameters.

The at least one parameter identifying said common traffic category may comprise at least one of following: traffic class (TC); allocation/retention priority (ARP); traffic handling priority (THP); bandwidth.

The means providing common traffic categories may comprise means providing common traffic category groups wherein said at least one group comprises at least two of said common traffic categories.

The means providing information as to how said common traffic categories are to be treated in said network may comprise means providing information for a first part of said telecommunications network resources as to how common traffic categories belonging to said at least one common traffic category group are to be treated in a first part of said telecommunications network.

### BRIEF DESCRIPTION OF THE DRAWINGS

Embodiments of the present invention will now be described by way of example with reference only to the accompanying drawings, in which:

FIG. 1 is a schematic diagram of the relationship between a communications system and a telecommunications management network;

FIG. 2 is a schematic diagram of a UMTS cellular telecommunications system;

FIG. 3 is a schematic diagram of the management architecture in a UMTS telecommunications system;

FIG. 4a shows an embodiment of the common traffic categorisation (treatment classes);

FIG. 4b is a schematic diagram of how DiffServ CodePoint is assigned to each different treatment class for the purposes of carrying the traffic on top of IP transport;

FIG. 4c is a schematic diagram showing how end-user services are assigned to treatment classes;

FIG. 5 shows a schematic diagram of a first embodiment of an interworking communications system between the service management system and the network management system based on common traffic categorisation;

FIG. 6 is a flow diagram for the interworking method between the service management system and the network management system as used in a first embodiment of the present invention;

FIG. 7a shows a schematic diagram of an embodiment according to present invention wherein the interworking system between the service management system, the network management system and the network is illustrated;

FIG. 7b is a flow diagram showing the interworking method between the service management system, the network management system and the network;

FIG. 8 is a schematic diagram of a UMTS network showing the situation where the number of treatments in each network domain differs and within which a second embodiment of the present invention may be implemented;

FIG. 9a is a schematic diagram showing the grouping of treatment classes into treatment groups as used in the second embodiment of the present invention;

FIG. 9b is a schematic diagram of a network management system within which the second embodiment of the present invention can be implemented;

FIG. 9c is a flow diagram showing the interworking method as used in a second embodiment of the present invention.

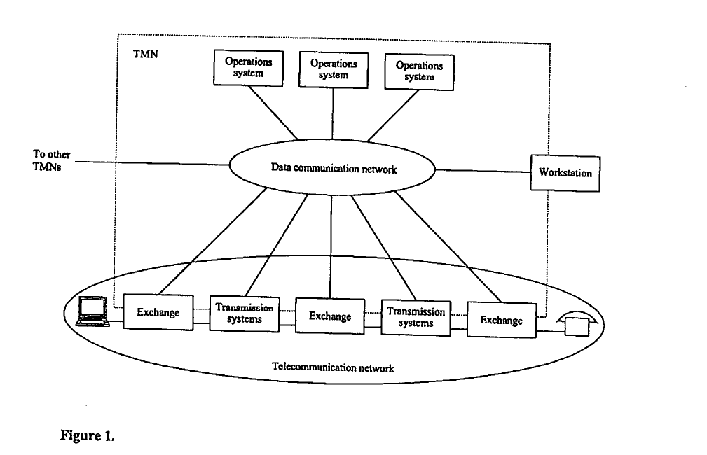

### DETAILED DESCRIPTION OF THE EMBODIMENTS OF THE PRESENT INVENTION

Embodiments of the present invention are described in which services and specific data types related to them receive uniform treatment throughout the network to meet all requirements set for a service and/or service subscription.

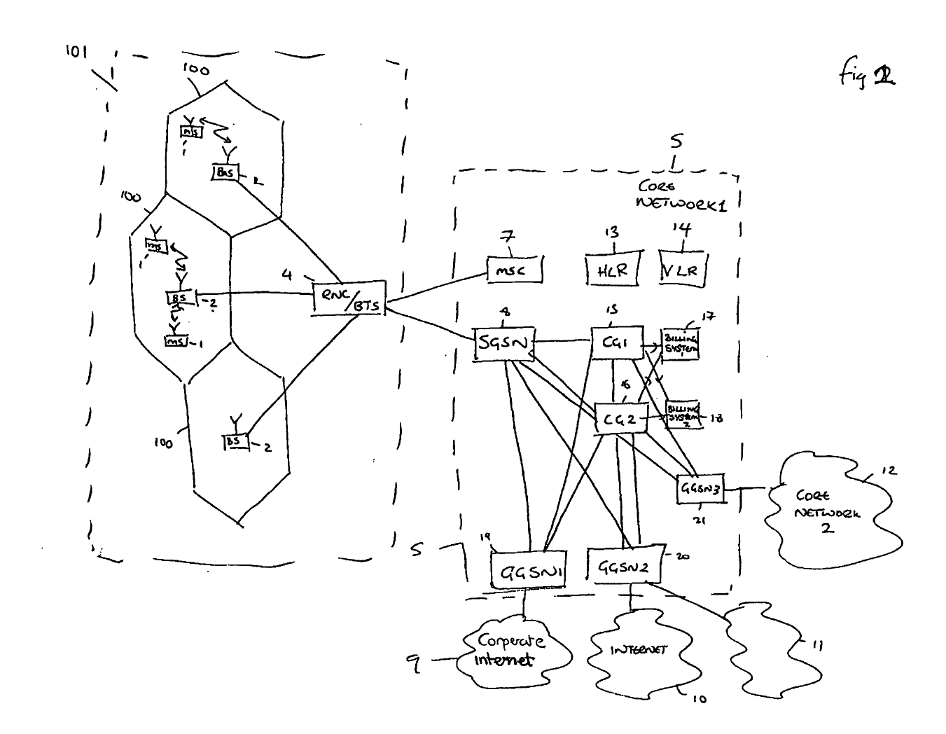

With reference to FIG. 2, the general logical architecture of UMTS/GPRS communications system in which embodiments of the present invention may be implemented is shown.

Various user equipment (UE) such as computers (fixed or portable), mobile telephones, personal data assistants or organisers and so on are known to the skilled person and can be used to access the Internet to obtain services. Mobile stations (MS) 1 are one example of user equipment that are capable of communication via a wireless interface with another device such as a base station of a mobile telecommunication network or any other station.

The term “service” used above and hereinafter will be understood to broadly cover any service, which a subscriber may desire, require or be provided with. The term also will be understood to cover the provision of complimentary services. In particular, but not exclusively, the term “service” will be understood to include Internet protocol multimedia IM services, conferencing, telephony, gaming, rich call, presence, e-commerce and messaging e.g. instant messaging.

The mobile station (MS) 1 can communicate by radio with one or more base stations (BS) 2. Each base station is linked to a single radio network controller (RNC) 4. The terminology used for base station and RNC will depend on the standard. For example, base stations can be referred to as “Node B” and RNCs as “base station controllers” (BSC). It should be appreciated that the terms “base station” and “RNC” should be interpreted as also encompassing equivalent elements in other standards which perform a similar function.

Each base station 2, is further arranged such that it is capable of receiving and transmitting to mobile stations 1 within an predefined area 100. These areas interlock and can partially overlap to create a patchwork of mobile station coverage. Each RNC 4 can be linked to one or more BSs 2. The BSs 2 and the RNCs 4 constitute a UMTS terrestrial radio access network (UTRAN) 101.

Each RNC 4 is linked to a core network (CN) 5. The CN 5 includes one or more serving nodes that can provide communication services to a connected mobile station, for example a mobile switching centre (MSC) 7 and a serving GPRS (general packet radio service) support node (SGSN) 8. These units are connected to the RNCs 4. The CN 5 is also connected to other telecommunications networks such as a fixed line network 9, other mobile networks (e.g. another core network 12) or packet data networks 10, 11 such as the Internet or proprietary networks to allow onward connection of communications outside the UMTS network. The CN 5 also includes other units such as a home location register (HLR) 13 and a visitor location register (VLR) 14 which help to control access to the network. The HLR 13 stores the subscription details of mobile station subscribers. The VLR 14 stores information on mobile stations that are currently attached to the CN 5 but which are not subscribed to that network.

Each core network 5 includes one or more charging gateway functionality entities 15, 16 and a billing system 17, 18 for performing billing operations.

In the core network each serving node such as an MSC or SGSN can provide a set of services to the mobile station. For example:

An MSC can provide circuit switched (CS) communications, for example for speech, fax or non-transparent data services, and therefore has a link to other entities in the circuit switched domain such as other CS mobile networks such as GSM (Global System for Mobile communications) and CS fixed wire networks such as conventional voice telephony networks.

An SGSN can provide packet switched (PS) communications, for example packet data protocol (PDP) contexts for Internet Protocol (IP) data transmission, and therefore has a link to other entities in the packet switched domain such as GPRS-equipped GSM networks and the Internet. The packet switched services may include traditional data services such as file transfer, e-mail and world-wide web (WWW) browsing, and derived data services such as voice-over-IP (e.g. by means of the H.323 protocol).

The Gateway GPRS support nodes (GGSN) 19, 20, 21 act as gateways between the core network elements and external networks the subscriber wishes to connect to. These external networks can for example be a packet switched network such as a corporate intranet 9 or the Internet 10, or a separate core network belonging to another network provider 12.

The division of functions between serving nodes is specified in the system specification and is tied to the assumed network architecture. For example there may be other nodes than the MSC or SGSN providing overlapping or additional functions.

The typical UMTS communications network as shown in FIG. 2 is managed by a management network, which typically comprises four logical management layers: the element management system layer, the network management system layer, the service management system layer and the business management system layer. As described previously the management system layers provide functionalities (OSFs) to manage the communications network and the management network itself.

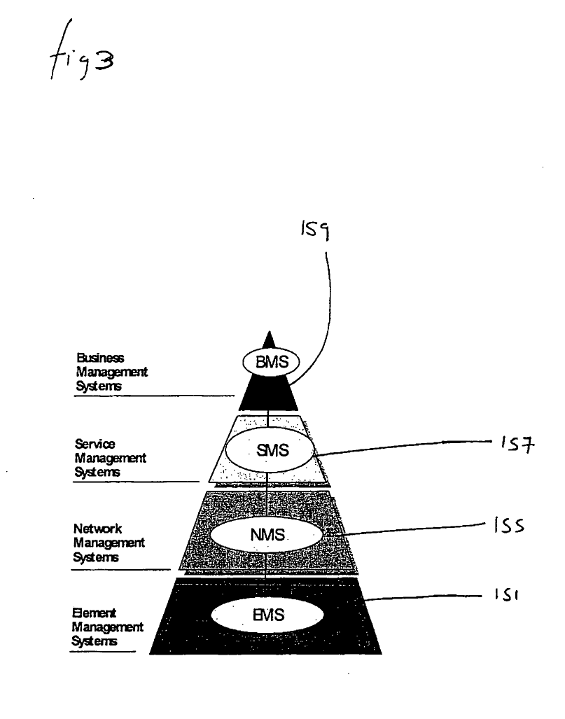

OSFs providing the management functionalities are implemented into OSs, like the element management system (EMS) 151, the network management system (NMS) 155, the service management system (SMS) 157 and the business management system (BMS) 159, the management network architecture of which is shown in FIG. 3. Some of the OSs can be closely integrated with each other. EMS and NMS are typically integrated providing for an operator a centralized management system to manage network resources. For example it may be possible to launch element managers specific to network element types into a NMS user interface. Management layers/systems are connected to each other and the network to be managed via a data communication network (DCN). The DCN is technology independent and may employ any single or combination of transmission technologies.

As discussed previously each service has a series of QoS requirements in order to function correctly and therefore expects certain characteristics from the network bearer in terms of delay (or latency), bandwidth and priority to access specific network resources, for example. These characteristics are defined as QoS parameters. The parameters can be used to control the network resources and their usage.

For example a service like voice-over-IP, to be usefully employed the voice data require data treatment which minimises the latency (as a long data delay would mean the receiver of the call experiencing a noticeable delay). Voice communication however does not require a particularly large bandwidth especially when compared against other subscriber services including streaming video which require higher bandwidths than voice but is less susceptible to latency problems.

Typically some or all of the characteristics and the QoS parameters are standardized, e.g. in case of UMTS they are standardized by 3rd Generation Partnership Project (3GPP). 3GPP develops global specifications for 3G mobile communications.

In order that services and specific data types related to the services receive uniform treatment throughout the network, embodiments of the invention provide a common traffic categorisation to be used by management layers, corresponding management systems, and the communication network. Without such common traffic categorisation it is not possible to configure the network resources in a consistent way to meet all requirements set for a service and/or for a service subscription.

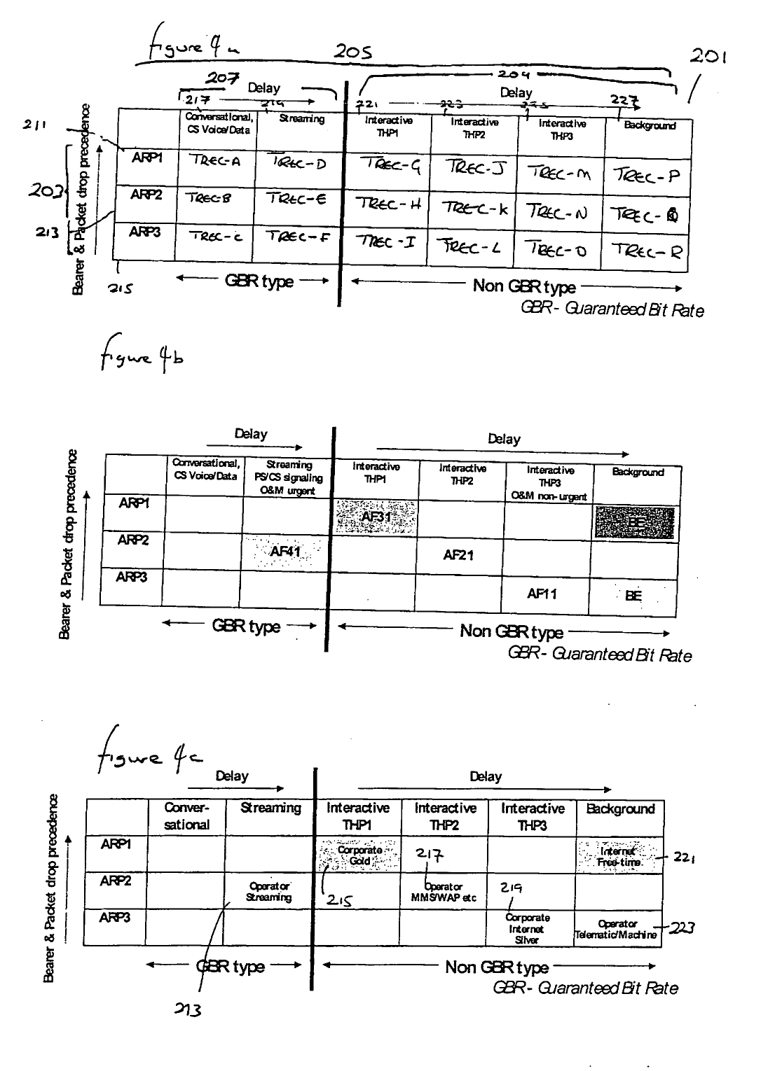

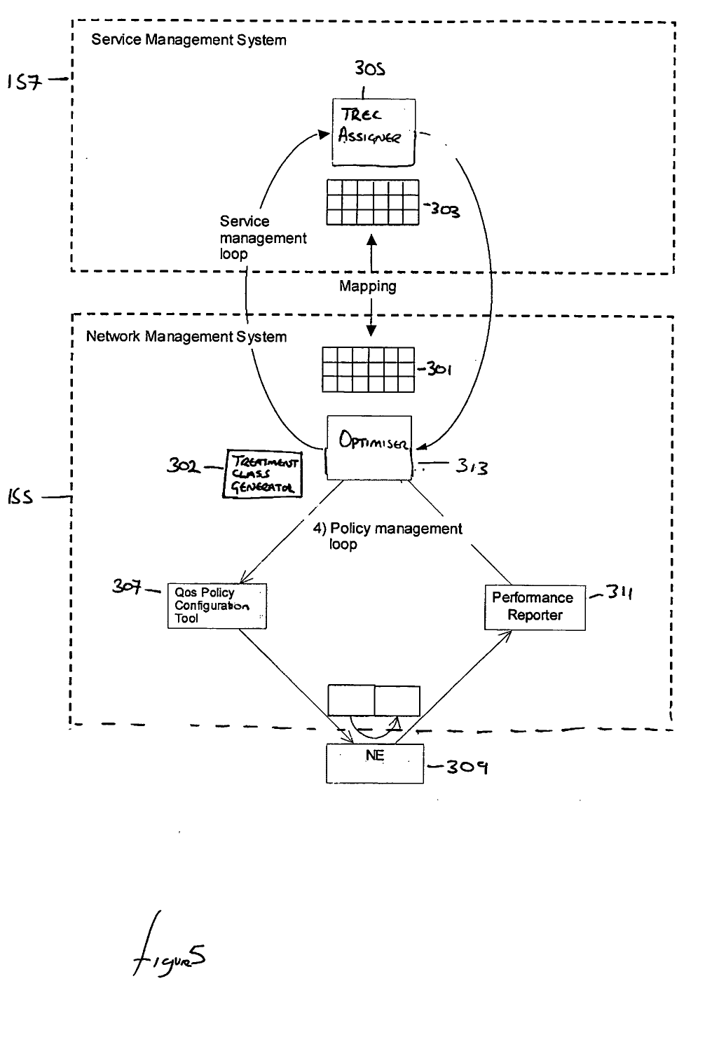

With reference to FIG. 4a an embodiment of the common traffic categorisation according to the present invention is visualised. A 3×6 treatment class matrix 201 comprises treatment class element values (TREC-A, TREC-B, . . . , TREC-R) in the three rows 211, 213, 215 and six columns 217, 219, 212, 223, 225, 227. Each of the treatment class (TREC) element values represents one common traffic category. It should be appreciated that the use of a matrix structure is presented here just for illustrating purposes. TRECs could be illustrated as well in a list or in a single row, for example.

In one embodiment of the present invention the defined common traffic categorisation (i.e. TRECs) data is stored in a management system, for example in NMS 155. TREC data definitions and possible changes in the definitions are informed to other parties (like other management layers/systems and the communication network) by using event messages. An event can include the TREC data (e.g. in a file), or it can be an indication for other parties to upload new TREC definitions via an API (application protocol interface). In other embodiments of the present invention TREC data is stored in order that the same data storage can be accessed by several parties. For example TREC data could be stored in a NE like HLR, or in some peripheral system, or TREC data can be stored in a management system and other interested parties can read the data via an API.

TREC data can be stored in a format of one or more text-files, in one or more XML-files, or in a database. These are mentioned here just as an example.

Likewise the size of the matrix 201 is only an example. Embodiments of the invention may utilize different numbers of TRECs. The numbers of TRECs, and the actual TREC definitions can be fixed or configurable on run-time.

In the embodiment presented in FIG. 4a the rows 203 of the treatment class (TREC) structure 201 represent the data traffic treatment in terms of allocation/retention priority (ARP) order. In other words treatment is expressed in terms of the different treatment that data packets receive as they are stored at the various network nodes and the order in which the data packets may be discarded if the memory buffers at the network nodes are full and begin to overflow. In the example provided by a first embodiment of the present invention there are three separate allocation/retention priority orders ARP1, ARP2, ARP3 and therefore three rows 211, 213, 215 of treatment class elements in the treatment class structure. For example the treatment class TREC-A has a higher allocation/priority (ARP) order, ARP1, than the treatment class TREC-B which has an allocation/priority order ARP2. Thus any data assigned to treatment class TREC-A would have a lower probability of packet loss than any data assigned to TREC-B. Similarly data using treatment class TREC-C with even lower allocation/priority order ARP3 would have a higher probability of packet loss than both treatment classes TREC-A and TREC-B.

In a similar manner any data assigned to the treatment class TREC-A would have a higher probability of being admitted to a communications node where the communications node is approaching overflow. Any data assigned to the treatment class TREC-B would have a lower probability of being admitted than the treatment class TREC-A. Also any data assigned to the treatment class TREC-C would have a lower probability of being admitted than any data in either treatment class TREC-B or treatment class TREC-C.

The columns 205 of the treatment class structure 201 are divided into two separate groups of columns. The first group of columns 207 represent the treatment classes where services require a guaranteed bit rate. These treatment classes are called guaranteed bit rate (GBR) type classes. The second group of columns 209 represent the treatment classes where services do not require guaranteed bit rates. These treatment classes are called non-guaranteed bit rate (Non-GBR) type classes.

The two types of classes 207, 209 are further divided and arranged in order of the expected delay for data passing through the network can experience. The guaranteed bit rate type columns 207 are divided into a higher and lower delay columns 217 and 219. In this embodiment the lower delay column 217 is referred to as the conversational column, used e.g. for voice over internet protocol (VoIP) traffic. The higher delay column 219 is referred to as the streaming column.

The non-guaranteed bit rate type columns 209 are divided into four columns. The first column 221 with the lowest delay expectation is known as the first interactive column with a first traffic handling priority (THP1). The second column 223 with the next lowest delay expectation is known as the second interactive class with a lower traffic handling priority (THP2) than the first interactive column. The third column 225 with a higher expected delay than either of the first two columns is known as the third interactive column with a lower traffic handling priority (THP3) than both the first and second interactive classes. The fourth column 227 with a higher expected delay than any of the previous three columns is known as the background column 227.

In the embodiment described in FIG. 4a the classification is based on QoS parameters Traffic Class, THP and ARP. In embodiments of the present invention the classification can be based to any QoS parameter or a set of QoS parameters.

In some embodiments of the invention, the common traffic categorisation may vary with time. For example, the categorisation used at a peak time may differ from the categorisation used at a non peak time.

Two examples of a populated treatment class structure are shown in FIG. 4b and FIG. 4c. FIG. 4b shows an example of a treatment class structure 201 as described in FIG. 4a where differentiated services (DiffServ) code points have been assigned to the various treatment classes. DiffServ code points (DSCPs) are known categories of data treatment service when applied within an Internet protocol (IP) network. For example the service AF41 is assigned to the treatment class TREC-E, the service AF31 assigned to the treatment class TREC-G, the service AF21 assigned to the treatment class TREC-K, the service AF11 assigned to the treatment class TREC-O, the service BE the treatment class TREC-P and the service BE the treatment class TREC-R. The network operator should have flexibility to configure which DSCP is used with each TREC.

With further reference to FIG. 4c the treatment class structure as described in FIG. 4a is populated with various services. For example the service Operator Streaming 213 is assigned to the treatment class TREC-E, the service Corporate gold 215 assigned to the treatment class TREC-G, the service Operator multimedia messaging service (MMS)/wireless access protocol (WAP) 217 assigned to the treatment class TREC-K, the service Corporate Internet Silver 219 assigned to the treatment class TREC-O, the service Internet Free-time 221 the treatment class TREC-P and the service Operator Telematic/Machine the treatment class TREC-R.

With the system as described earlier the network management system 155 and the service management system 157 are able to keep synchronized a series of services and the treatment assigned to each and therefore maintain a uniform treatment for the same service independent of the traffic conditions.

With reference to FIG. 5 a generic idea of interworking within a communications system, using a common traffic categorisation in order to provide uniform treatment of traffic data, is shown. The system comprises a service management system 157 and a network management system 155 connected to each other via a DCN (not shown).

The service management system 157 comprises a treatment class (TREC) assigner 305, and a memory 303 for storing treatment class data. An operator, a service provider, or a service subscriber typically uses the assigner 305, but the assigner can comprise functionality capable of allocating appropriate treatment classes to services automatically.

The network management system 155 comprises a network management system optimiser 313, a treatment class generator 302 for creating the common traffic categorisation, a memory for storing treatment class (TREC) data 301, a quality of service policy configuration tool 307, a performance reporter 311. The optimiser 313 is typically arranged within the NMS, which with or without operator's contribution, to calculate a more optimal network configuration. In some embodiments of the present invention the optimisation is done manually by the network operator. The operator is the operator of the network and/or a service provider. In some embodiments of the present invention the functionality of treatment class generator 302 is implemented into the QoS policy configuration tool 307 (not shown in FIG. 5).

In addition in FIG. 5 is presented a telecommunication network Oust one network element (NE) 309 shown for simplicity).

In some embodiments of the present invention the memory for storing a treatment class data can be located outside of the service management system 157 and the network management system and the memory is accessed via an API.

In the NMS 155, the QoS (Quality of Service) policy configuration tool 307 controls that the traffic is treated according to the agreed categorisation. Additionally, as the NMS 155 takes care that the QoS targets promised by the NMS to the SMS 157 are maintained, the operator can continuously control QoS targets agreed in e.g. subscribers SLAs (service level agreements). The NMS 155 with the control loop of the NMS optimiser 313, the QoS policy configuration tool 307, the Network Element 309 and the performance reporter 311, further is arranged to control the network in order to maintain the network to carry the promised data traffic belonging to each treatment class.

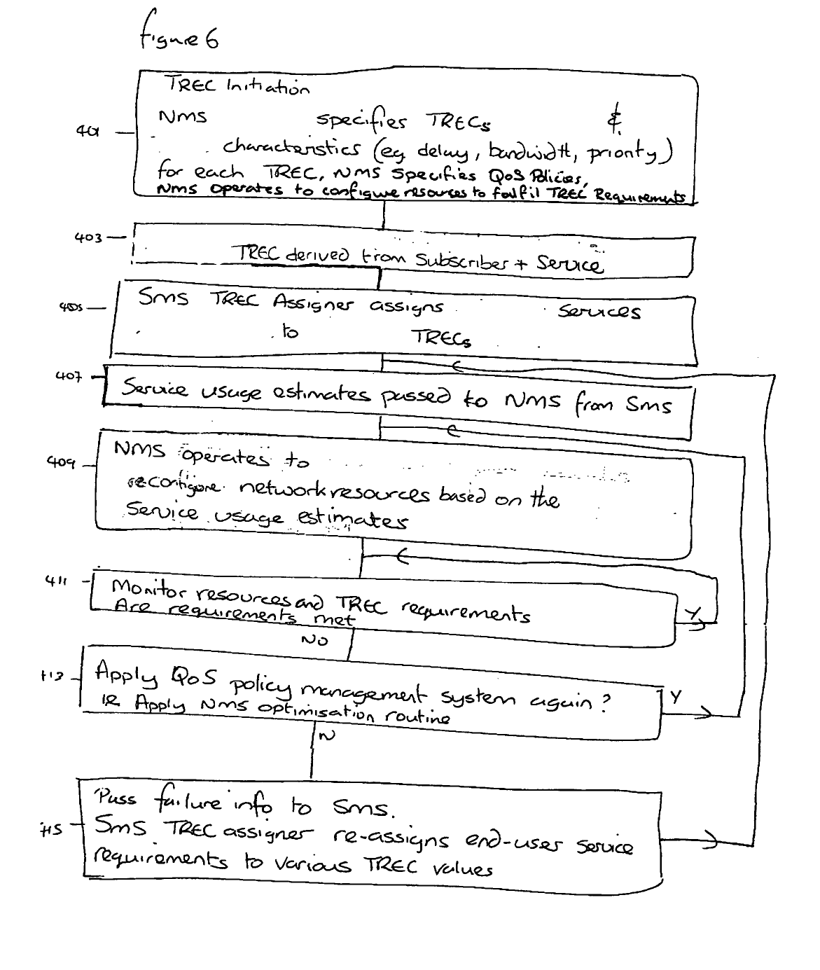

With reference to FIG. 6 the creation and use of such treatment classes 201 is further described.

In the first step 401 treatment classes 201 are initiated. First TRECs such as that described previously with reference to FIG. 4a are created, or modified if already existing. Each of the treatment classes has defined QoS requirements. These QoS requirements can in some embodiments of the present invention be minimum QoS requirements and in some embodiments average QoS requirements, or they can be a combination of minimum and average QoS requirements. Treatment classes are therefore defined in terms of QoS characteristics such as delay, bandwidth and priority in the network. Further in this step the network management system 155 operates to configure network resources to fulfil QoS requirements according to defined TRECs. In other words the quality of service (QoS) policy configuration tool 307 creates, or modifies if already existing, QoS policies for network resources. Policies are used for handling the data traffic for the service dependent on the QoS policy. NMS 155 then sets up the network resources by deploying the policies to the network nodes 309 handling the data traffic. These nodes include e.g. routers, gateways, nodes of the core network, as well as the base station controllers/radio network controllers and the base stations.

In some embodiments of the present invention the NMS 155 provides service level specifications (SLSs) for each TREC. These SLSs define the characteristics of each treatment class. These defined characteristics include e.g. the target traffic delay, the available bandwidth and the priority of the traffic. For example, the treatment class TREC-D may have a one second delay target, and have a capacity of 300 kilobits per second, and have an allocation/retention priority ARP1 (in other words the treatment class has a high priority).

Each of the treatment classes are associated with a specific quality of service (QoS) policy as decided in the network management system 155 within the QoS policy configuration tool 307.

According to one embodiment of the present invention, the treatment class data is stored both in the memory 301 within the network management system 155 and in the memory 303 of the service management system 157.

In next step 403 appropriate treatment class to be used are derived from the subscriber and used service requirements.

In the following step 405 the TREC assigner 305 in the SMS 157 assigns or maps the specific subscriber service to a specific TREC. For example if a subscriber service in the form of an interactive multiplayer real time network game requires a delay of no more than 1.5 seconds, and with medium susceptibility to packet loss, then the treatment class assigner 305 examines the stored treatment class data 201 stored in the memory 303. If the data features treatment classes TREC-H with an estimated delay of 0.5s, TREC-K with an estimated delay of 1.2s and TREC-N with an estimated delay of 3s, the TREC assigner determines that TREC-K with a 1.2s delay target is acceptable and therefore the game service is assigned to treatment class TREC-K. The game service is not assigned to TREC-N because the delay is greater than the requirement. Although the game service could be assigned to the treatment class TREC-H, as it contains an estimated delay better then the requested delay requirement, it would not usually be chosen as it would be seen to be unnecessarily good for the game service.

In embodiments where service level specifications are generated by the NMS the SMS uses these SLS values when assigning a service to an appropriate TREC.

The next step 407 occurs when the service management system 157 passes the service usage estimates to the network management system 155 in the form of the assigned service-treatment classes.

In the following step 409, the network management system 155 uses the information passed by the service management system 157 in step 407, and operates to reconfigure network resources to fulfil TREC requirements defined in step 401. In other words the network management system 155 quality of service (QoS) policy configuration tool 307 modifies QoS policies, if needed, based on the service usage estimates, to meet the requirements set for TRECs. Then NMS 155 sets up the network resources by deploying the policies to the network nodes 309 handling the data traffic.

In some embodiments of the present invention the deployment of the policy information is at least partially managed by the element management system 151.

In the step 411 the network management system performance reporter 311 gathers information referring to the treatment of the various types of data in the network. The performance reporter passes this information onto the NMS optimiser 313 which determines if the TREC requirements are being met.

If the requirements are currently met then the network management system maintains its monitoring mode. If the requirements are not being met the method passes to step 413. In step 413 the NMS optimiser determines if it is necessary to calculate more optimal network configuration and to run another iteration of the QoS policy configuration tool 307 to attempt to improve the configuration of the network resources in order fulfil the TREC requirements. In some embodiments of the present invention this decision may be chosen dependent on a fixed number of iterations. In other embodiments of the present invention the decision to re-iterate may be made dependent on whether past iterations have significantly improved the networks ability to fulfil the TREC requirements. If it is decided to run a further iteration the method passes back to step 409. If it is decided not to run a further iteration the method passes forward to step 415.

In step 415 the NMS passes the performance report to the service management system 157. The service management system 157 then re-examines the resource requirement and current service performance and reassigns in the TREC assigner 305 the service to a more appropriate treatment class. Thus effectively the method passes back to step 407.

For example using the same example described earlier, if the actual delay using the treatment class TREC-K is actually 2.5 seconds and cannot be decreased down to the 1.5s level, the performance reporter 311 sends an indication e.g. an event message to the service management system 157. The service management system 157 in the TREC assigner 305 then reassigns the interactive multimedia game service to the treatment class TREC-H which had an initial smaller estimated delay.

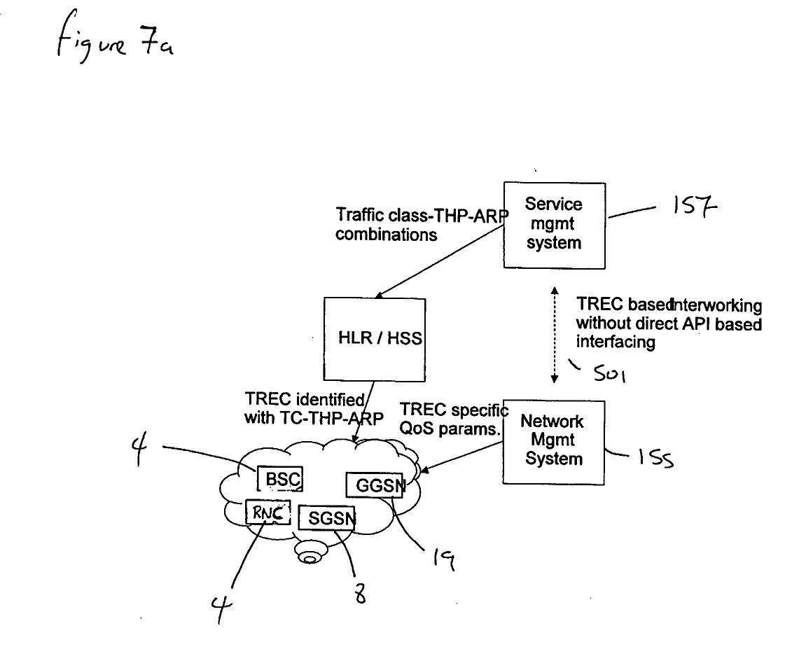

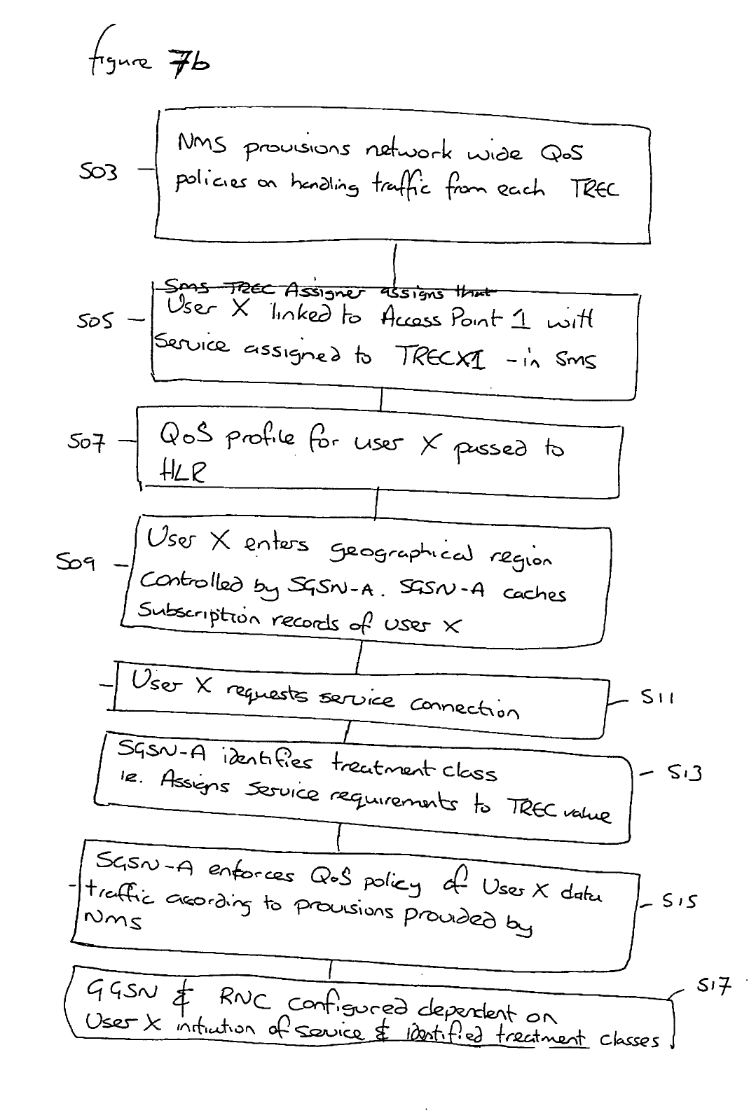

With reference to FIG. 7a an embodiment of the present invention is described wherein TRECs defined according to the present invention and allocated to services are delivered further into a communications network. The embodiment shown in FIG. 7a comprises the service management system 157, the network management system 155, the home location register 13, and ancillary control nodes such as the support GPRS service node (SGSN) 8, the gateway GPRS service node (GGSN) 19, the radio network controller 4 (RNC), and the base station controller 4 (BSC).

The service management system 157 is connected to the home location register (HLR) 13 via a DCN (not shown). The service management system 157 is capable of passing data describing a UMTS traffic class (TC), traffic handling priority (THP), and allocation/retention priority (ARP) combination to the home location register (HLR) 13. Subscriber specific QoS profile (containing the TC-THP-ARP information for TREC identification) can be passed from HLR to the SGSN 8. The SGSN 8 identifies from the QoS profile the TREC specific to the PDP context requested. The SGSN 8 can then pass the QoS profile to the GGSN 19. The GGSN 19 in turn identifies the TREC requested from the QoS profile. The GGSN 19 further can pass a response (containing the QoS profile) back to the SGSN 8. The SGSN 8 is arranged to pass the QoS profile to the RNC 4. The RNC 4 is further arranged to identify the TREC of the PDP context requested from the QoS profile.

The network management system 155 is connected via a DCN (not shown) to the SGSN 8, the GGSN 19, and the RNC 4 and is capable of passing the treatment class specific quality of service parameters from the network management system 155 to the SGSN 8, GGSN 19 and RNC 4.

With reference to FIG. 7b an interworking method of the embodiment will be described with reference to FIG. 7a.

In the first step 503 the network management system 155, in the form of the QoS policy configuration tool 307 supplies the network elements/nodes with information relating to the quality of service for defined treatment classes (TRECs). In other words nodes such as the SGSN 8, the GGSN 19, and the RNC 4 are supplied with information relating to how to handle traffic depending on the treatment class.

The next step 505 occurs as the service management system 157 is configured to allow a subscriber (for example subscriber X) operating user equipment to use an access point (such as allowing a subscriber to access the Internet 10 via a known GGSN 19) with the treatment class TREC-X1. The treatment class TREC-X1 has already been predefined as being of a specific UMTS traffic class with a predefined allocation/retention priority (ARP), and traffic handling priority (THP).

The next step 507 occurs as the quality of service (QoS) profiles for the subscriber is passed to the home location register 13 from the service management system 157. In other words the HLR is loaded with the various treatment classes that correspond to the services that the subscriber is capable of carrying out.

The subscriber is capable of roaming within the network. When the subscriber enters the geographical region controlled by a specific SGSN (for example SGSN-A) then the next step 509 is applied. In this step the SGSN caches the subscriber's subscription records stored in the home location register 13. This step 509 can occur without the subscriber requesting a service.

However when the subscriber X requests a service connection as indicated in step 511 the process proceeds to step 513.

The SGSN in step 513 identifies the treatment class required by the subscriber. For example SGSN-A identifies that data for subscriber X is assigned to treatment class TREC-X1.

In step 515 the SGSN enforces the quality of service policy which is identified by the treatment class according to the network provisions provided by the network management system 155 in step 503. Thus there is no direct interfacing between the service management system 157 and the network management system 155.

A further step 517 occurs as the associated GGSN and associated radio network controller (RNC) are also configured dependent on the QoS policy passed to the GGSN and RNC and therefore dependent on the identified treatment class. In practice the SGSN 8 passes the QoS profile to the GGSN 19. The GGSN 19 identifies the TREC requested from the QoS profile, and applies the configuration based on this treatment class. The GGSN 19 passes a response (containing the QoS profile) back to the SGSN 8. The SGSN 8 passes this QoS profile to the RNC 4. The RNC 4 identifies the TREC of the PDP context requested from the QoS profile and applies the configuration based on this treatment class.

Thus the network is now configured to allow the subscriber to use services via these nodes in order to access the required access point with an acceptable traffic treatment.

Treatment classes in a further embodiment of the invention can also be applied in an element management system. In this embodiment the treatment classes (TRECs) are configured to network elements by EMS, e.g. when the NMS delegates the QoS configuration functionality to the element management system. The element management system then configures network element parameters NE by NE.

With reference to FIG. 8 a telecommunications network wherein a second embodiment of the present invention may be applied is described in detail. The network comprises a first treatment group domain 609 comprising three routers 601, 603 and 605. Each router is connected to the other two routers.

Furthermore the router 603 is connected to a second treatment group domain 611. The second treatment group domain comprises a gateway GPRS service node (GGSN) 19.

The router 601 is further connected to a third treatment group domain. The third treatment group domain comprises a serving GPRS service node (SGSN) 8.

The routers 601, 603, 605 each comprise memory units (not shown) having only three separate queues for storing data packets passed to each of the routers. The first queue being the expedited forwarding (EF) for all real time traffic, the second queue being the assured forwarding (AF) for all interactive traffic and a third best effort (BE) queue for background traffic. Thus the first treatment group domain 609 has only three different delay categories and therefore only three different possible data treatments.

In the SGSN and GGSN in the treatment group domains 2 and 3 the typical UTMS traffic treatment classes such as the 6×3 treatment structure defined earlier is available. This 6×3 TREC structure has six different treatment column categories defined as: conversational, streaming, interactive THP 1, interactive THP 2, interactive THP 3, and background.

Thus there is the problem of defining treatment classes that can be used for both the treatment group domain 2 and domain 3, with their 6×3 treatment class structures, and the treatment group domain 1.

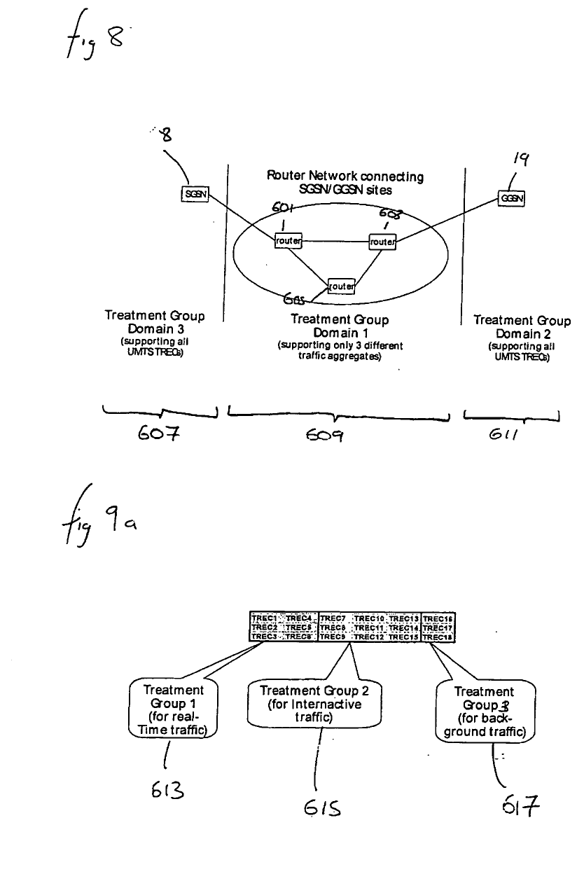

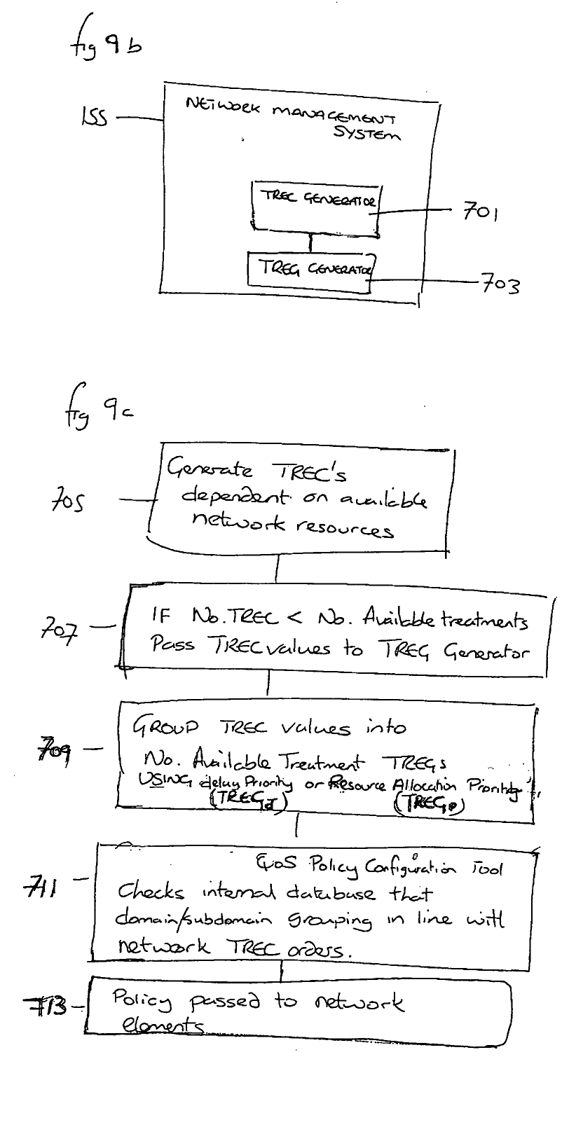

With reference to FIG. 9b a network management system embodying the second embodiment of the present invention is shown. The network management system is capable of managing the data treatments for the required service over all three domains. The network management system comprises a TREC generator 701 (similar to the TREC generator used in the first embodiment described previously), and a treatment group (TREG) generator 703. The TREC generator 701 is connected to the TREG generator 703.

With reference to FIG. 9c the method used by the second embodiment of the present invention is described. The first step 705 of the method used in the second embodiment is similar to the first step of the first embodiment in that the network management system generates a series of treatment classes (TRECs) dependent on the available network resources. For example the 6×3 TREC structure as described previously is created. In the same step this TREC structure can be passed to the network elements and management systems requiring it, for instance to the service management system (not shown in FIG. 9b).

In the next step the quality of service (QoS) policy configuration tool 307 within the network management system (as shown in FIG. 5) determines if the number of treatment classes produced by the TREC generator 301 is greater than the number of available treatments in the domains. If this is the case then the treatment classification values are passed to the treatment group (TREG) generator 703.

In the next step 709 the treatment group (TREG) generator groups or compounds the various treatment classes (TRECs) into a number of treatment groups (TREGs) for example so that the number of TREGs is equal to the number of available treatments.

Two possible grouping algorithms applied by embodiments of the present invention are grouping by delay or grouping by priority. The first grouping algorithm groups the various treatment classes dependent on their estimated delay. If there is for example several treatment classes: treatment class TREC-X with a delay of 0.5 seconds, treatment class TREC-Y with a delay of 1 second and treatment group TREC-Z with a delay of 7 seconds the treatment group generator 703 groups the classes X and Y to form the treatment Group TREG-alpha and the treatment class Z to form the treatment group TREG-beta.

The second grouping algorithm compounds the various treatment classes dependent on their priority.

In grouping by delay (TREG_{d}) all of the traffic belonging to the same delay treatment group receive the same delay treatment in the territory of the grouping. In contrast all of the traffic belonging to the same priority treatment group (TREGₚ) receive the same priority treatment in the territory of the grouping.

The step 711 occurs where the quality of service (QoS) policy configuration tool 307 checks the internal database at the domain or sub-domain groupings are in line with the quality of service (QoS) network management treatment class orders. In other words the management system checks e.g. that the network delay configuration is capable of being configured in such a way that permits the TRECs belonging to the same TREG to be capable of receiving the same estimated delay treatment.

Finally, in step 713 if the consistency check is passed then the policies affecting the delay can be deployed to the network elements. Thus where the second embodiment of the invention is used the policy information is passed to the various network elements such as the SGSNs 8, GCSNs 19 and RNCs 4 to await a subscriber service request.

With reference to FIG. 9a an example of such a grouping of treatment classes can be seen wherein treatment classes can be seen wherein treatment classes TREC1 to TREC6 have been grouped as treatment group 1 (for real time traffic) 613, the treatment classes TREC7 to TREC15 have been grouped into treatment group 2 (for interactive traffic), and treatment classes TREC16 to TREC18 have been grouped into treatment group 3 (for background traffic).

Embodiments of the invention can be used for carrying traffic on the top of any other type of radio bearers, on top of ATM treatments or the like.

The embodiments described above have been discussed in context of a GPRS or UMTS communication system. The present invention as shown in the embodiments can also be applied to other communications systems implementing TMN principles presented by ITU-T.

Embodiments of the invention have been described in the context of a network management system and a service management system. Embodiments of the invention can also be applied in other network management layers.

Embodiments of the invention have been described in the context of a packet switched environment. Embodiments of the invention can also be applied in circuit switched environments.

1. A method for service management in a telecommunications network, wherein at least one service is accessible via said network, and said network is managed by management systems, said method comprising the steps of:
providing common traffic categories;
providing information for said common traffic categories as to how respective common traffic categories are to be treated in a network;
allocating a common traffic category of said common traffic categories to at least one service;
treating said at least one service in said network in accordance with said information.

2. The method according to claim 1, wherein said step of providing common traffic categories comprises defining at least one parameter for at least one traffic category.

3. The method according to claim 2, wherein said step of defining comprises defining at least one of said common traffic categories by at least one value of said at least one parameter.

4. The method according to claim 2, wherein said step of defining comprises defining a plurality of parameters for the at least one traffic category, wherein said at least one traffic category includes values for each of the plurality of parameters.

5. The method according to claim 2, wherein said step of defining said at least one parameter comprises defining at least one of following parameters:
traffic class;
allocation/retention priority;
traffic handling priority; or
bandwidth.

6. The method according to claim 1, further comprising providing common traffic category groups, wherein at least one traffic category group comprises at least two of said common traffic categories.

7. The method according to claim 6, wherein said step of providing for said common traffic categories information further comprises the step of:
providing information for a first part of said network as to how common traffic categories belonging to said at least one common traffic category group are to be treated in said first part of said network.

8. A communications system, comprising:
a first management function and a second management function, said first and second management functions using common traffic categories, said first management function controlling traffic treated in dependence on an allocated common traffic category of said common traffic categories and said second management function allocates an appropriate common traffic category to a service.

9. A communications system as claimed in claim 8, further comprising a communications network, wherein said first management function to control that traffic associated with said service is treated in said network according to the common traffic category allocated to the service.

10. A communications system as claimed in claim 8, further comprising at least one memory for storing common traffic category information, wherein said at least one memory is provided in said first or second management function.

11. A communications system as claimed in claim 10, wherein a memory is provided in each of said first and second management functions, wherein a first memory stores said common traffic category information and a second memory is to the common traffic category information stored in the first memory.

12. A communications system as claimed in claim 8, wherein a memory is provided separate from said first and second management functions, wherein said memory stores common traffic category information, and said memory is accessible by both of said management functions.

13. A communications system as claimed in claim 12, wherein said memory is in a communications node of said network or in a third management function.

14. A communication system as claimed in claim 8, wherein said common traffic categories comprise a group of guaranteed bit rate categories.

15. A communications system as claimed in claim 14, wherein said guaranteed bit rate categories comprise at least one of a conversational data category and a streaming data category.

16. A communications system as claimed in claim 8, wherein said common traffic categories comprise a group of non-guaranteed bit rate categories.

17. A communications system as claimed in claim 16, wherein said non-guaranteed bit rate categories comprise at least one of a first interactive data treatment with a first traffic handling priority, a second interactive data treatment with a second traffic handling priority, a third interactive data treatment with a third traffic handling priority, and a background data treatment.

18. A communications system as claimed in claim 8, wherein said common traffic categories comprise three groups, each group having a different allocation or retention or priority.

19. A communications system as claimed in claim 8, wherein said common traffic categories comprise common traffic category groups, said common traffic category groups comprising associated common traffic categories, wherein said first management function determines resources dependent on said common traffic category groups in a first part of said system, and to determine resources dependent on said associated common traffic categories in a second part of said system.

20. A communications system as claimed in claim 8, wherein at least one communications node receives information from said second management function defining said allocated common traffic category for said service and information from said first management function about the allocated common traffic category.

21. A communications system as claimed in claim 20, wherein said allocated common traffic category information comprises at least one parameter relating to treatment of traffic associated with said service.

22. A system as claimed in claim 20, wherein said at least one communications node comprises at least one of gateway general packet radio service support node, radio network controller and servicing general packet radio service support node.

23. A system as claimed in claim 20, wherein said second management function provides said traffic category information for said service to said at least one node via an home location register.

24. A communications system as claimed in claim 8, wherein said communications system is a universal mobile telecommunications system architecture communications system.

25. A communications system as claimed in claim 8, wherein said communications system is a general packet radio service architecture communications system.

26. A communications system as claimed in claim 8, wherein said first management function is a network management system.

27. A communications system as claimed in claim 8, wherein said second management function is a service management system.

28. A system as claimed in claim 8, wherein n categories are provided and a part of said network is able to only process m categories where m<n, wherein said n categories are divided into m groups or less.

29. A communications system as claimed in claim 8, wherein said first management function provides information relating to said common traffic categories to at least one communications node.

30. A communications system as claimed in claim 29, wherein said at least one communications node to which said information relating to said common traffic categories is passed comprises at least one of a servicing general packet radio service node, gateway general packet radio service node, base station controller and radio network controller.

31. A communications system as claimed in claim 29, wherein said at least one communications node enforces at least one parameter of said allocated common traffic category.

32. A telecommunications network wherein at least one service is accessible via said network, and said network is managed by management systems, said network comprising:
first providing means for providing common traffic categories;
second providing means for providing information as to how said common traffic categories are to be treated in said network;
allocating means for allocating a common traffic category of said common traffic categories to at least one service;
wherein said network treats said service in said network in accordance with said information as to how said common traffic categories are to be treated in said network.

33. A telecommunications network according to claim 32, further comprising a first management system comprising said first providing means for providing said common traffic categories or second providing means for providing information as to how said common traffic categories are to be treated in said network.

34. A telecommunications network according to claim 32, further comprising a second management system comprising said allocating means for allocating said common traffic category of said common traffic categories to at least one service.

35. A telecommunications network according to claim 32, wherein said first providing means for providing common traffic categories comprises third providing means for providing at least one parameter, wherein at least one of said common traffic categories includes at least one value or a range of values of said at least one parameter.

36. A telecommunications network according to claim 32, wherein said first providing means for providing common traffic categories comprises third providing means providing a plurality of parameters, wherein at least one of said common traffic categories includes values of said plurality of parameters.

37. A telecommunications network according to claim 35, wherein said at least one parameter is one of following:
traffic class;
allocation/retention priority;
traffic handling priority; or
bandwidth.

38. A telecommunications network according to claim 32, wherein said first providing means for providing common traffic categories comprises third providing means for providing common traffic category groups wherein said at least one common traffic category group of said common traffic category comprises at least two of said common traffic categories.

39. The telecommunications network according to claim 38, wherein said second providing means for providing information as to how said common traffic categories are to be treated in said network comprises fourth providing means for providing information for a first part of said telecommunications network resources as to how said at least two of said common traffic categories belonging to said at least one common traffic category group are to be treated in a first part of said telecommunications network.
